(19) United States
(12) Patent Application Publication
(10) Pub. No.: US 2023/0250845 A1
(43) Pub. Date: Aug. 10, 2023

(54) GAS EXCHANGE CHAMBER

(71) Applicant: Aquarius Engines (A.M.) Ltd., Yakum (IL)

(72) Inventor: Shaul Haim YAAKOBY, Alsdorf (DE)

(73) Assignee: Aquarius Engines (A.M.) Ltd., Yakum (IL)

(21) Appl. No.: 18/003,296

(22) PCT Filed: Nov. 16, 2020
(86) PCT No.: PCT/IB2020/060777

§ 371 Date: Dec. 23, 2022

Related U.S. Application Data
(60) Provisional application No. 63/044,096, filed on Jun. 25, 2020.

(51) Int. Cl. F16C 5/00; F16C 29/02

(52) U.S. Cl. CPC F16C 5/00; F16C 29/02; F16C 2360/22; F01B 9/026

(57) ABSTRACT

An engine may be configured to have a piston reciprocate in a cylinder in which blow-by gases pass from a combustion chamber in the cylinder to an area external to the cylinder. The piston may be connected to a rod configured to reciprocate in a linear path. The engine may comprise a gas exchange chamber configured to trap the blow-by gases in a space between the cylinder and a chamber housing an actuator connected to an end of the rod.

### CROSS-REFERENCE TO RELATED APPLICATIONS

This application claims priority to U.S. Provisional Application No. 63/044,096, filed Jun. 25, 2020.

### TECHNICAL FIELD

The present disclosure relates to the field of internal combustion engines, and may more particularly relate to the field of internal combustion engines having a gas exchange chamber adjacent to a combustion chamber of a cylinder.

### BACKGROUND

Internal combustion engines are known. Some engine configurations include single or multi-cylinder piston engines, opposed-piston engines, and rotary engines, for example. The most common types of piston engines are two-stroke engines and four-stroke engines. These types of engines include a relatively large number of parts, and require numerous auxiliary systems, e.g., lubrication systems, cooling systems, intake and exhaust valve control systems, and the like, for proper functioning.

Some engines may be configured to have an oscillating mass (e.g., a piston) reciprocate in a linear path. A free piston engine may be one example of an engine with a piston reciprocating in a linear path. Such engines may be useful as a power generation source because they are not strictly constrained by a crankshaft and may simplify some aspects of design. A free piston engine may also allow for enhanced flexibility in ignition timing, types of fuel used, and may be well-suited for generating electric power by way of coupling to an energy transformation device.

However, some engines may face issues with contamination of lubricant or other materials or components of the engine. For example, blow-by gases (e.g., gases that escape from a combustion chamber, blowing past a barrier and infiltrating another chamber) may leak into a chamber housing the lubricant. Alternatively, even when no lubricant is used, blow-by gases may enter a chamber and contaminate components therein (e.g., coils of an electric generator). Various improvements in systems and methods relating to engines are desired.

### SUMMARY

Some embodiments may relate to an internal combustion engine, such as a linear reciprocating engine. An engine may be configured to have a piston reciprocate in a cylinder in which blow-by gases pass from a combustion chamber in the cylinder to an area external to the cylinder. The piston may be connected to a rod configured to reciprocate in a linear direction. The engine may comprise a gas exchange chamber configured to trap the blow-by gases in a space between the cylinder and a chamber housing an actuator connected to an end of the rod.

Exemplary advantages and effects of the present invention will become apparent from the following description taken in conjunction with the accompanying drawings wherein certain embodiments are set forth by way of illustration and example. The examples described herein are just a few exemplary aspects of the disclosure. It is to be understood that both the foregoing general description and the following detailed description are exemplary and explanatory only and are not restrictive of the invention.

### BRIEF DESCRIPTION OF THE DRAWINGS

FIG. 1 is a diagrammatic representation of an engine with a gas exchange chamber, consistent with embodiments of the present disclosure;

FIGS. 2A-D are diagrammatic representations of operation of an engine with a gas exchange chamber, consistent with embodiments of the present disclosure;

FIG. 3 is a perspective view of a piston kit and gas exchange chamber, consistent with embodiments of the present disclosure;

FIG. 4 is a bottom perspective view of the gas exchange chamber of FIG. 3, according to an embodiment of the present disclosure;

FIG. 5 is a top perspective view of the gas exchange chamber of FIG. 3, according to an embodiment of the present disclosure;

FIG. 6 is a top view of the gas exchange chamber of FIG. 3, according to an embodiment of the present disclosure;

FIG. 7 is a bottom view of the gas exchange chamber of FIG. 3, according to an embodiment of the present disclosure;

FIG. 8 is a side view of the gas exchange chamber of FIG. 3, according to an embodiment of the present disclosure;

FIG. 9 is a cross-sectional view of the gas exchange chamber of FIG. 3, according to an embodiment of the present disclosure;

FIG. 10 is a side cross-sectional view of the gas exchange chamber of FIG. 3, according to an embodiment of the present disclosure;

FIGS. 11A-11G illustrate sectional views of an engine at a various operational positions, consistent with embodiments of the present disclosure; and

FIGS. 12A-12C illustrate sectional views of an engine, consistent with embodiments of the present disclosure.

### DETAILED DESCRIPTION

Reference will now be made in detail to exemplary embodiments, examples of which are illustrated in the accompanying drawings. The following descriptions refer to the accompanying drawings in which the same numbers in different drawings may represent the same or similar elements unless otherwise represented. The implementations set forth in the following description of exemplary embodiments do not represent all implementations consistent with the invention. Instead, they are merely examples of systems, apparatuses, and methods consistent with aspects related to the invention as may be recited in the claims. Relative dimensions of elements in drawings may be exaggerated for clarity.

In an internal combustion engine, combustion in a combustion chamber may cause expansion gases to reach high pressure, causing a piston to move so that energy can be extracted from mechanical motion of the piston. The piston may have a piston ring circumscribing the piston and may form a seal against the walls of a cylinder. Also, the cylinder head may have a gasket configured to seal other areas of the cylinder and form a sealed combustion chamber. Ideally, expansion gases are fully contained in the combustion chamber until the engine reaches an exhaust phase. However, in reality, there may be some expansion gases that escape past the seals during combustion. For example, there may be “blow-by gases” that blow past barriers such as the piston or gasket and escape outside the combustion chamber. These gases may contain combustion products (e.g., burned or unburned fuel) and may contaminate oil or other materials outside the combustion chamber. The chamber outside the combustion chamber may be in direct communication with oil used to lubricate a component of the engine (e.g., a crankcase housing a crankshaft). Blow-by gases may be a factor contributing to the need to periodically change engine oil.

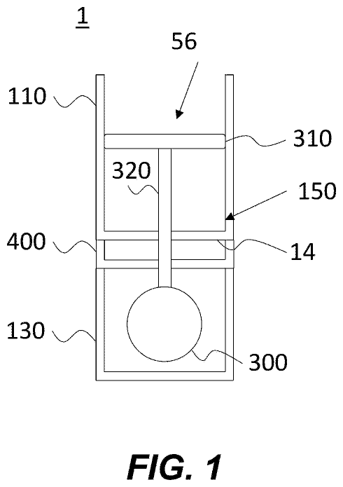

Furthermore, an engine may have an arrangement of a cylinder that houses a piston configured to move up and down, with a combustion chamber formed below the piston (see FIG. 1). A piston rod may extend through the combustion chamber and to a location outside the cylinder. The piston rod may connect to an actuator configured to transform motion of the piston and piston rod to output of some other form. For example, the actuator may include a mechanism configured to transform linear reciprocating motion of an end of the piston rod to rotative motion (e.g., rotation that may be used to rotate a wheel). The actuator may be housed in a chamber that contains lubricant, and thus is sensitive to contamination. Or, for example, the actuator may be one that does not use lubricant, but still includes components that are sensitive to contamination, such as an electrical generator having coils.

In some embodiments of the disclosure, an engine may be provided that includes a gas exchange chamber between a combustion chamber and an actuator. The gas exchange chamber may be configured to prevent contaminants from reaching the actuator or related components or materials. For example, the gas exchange chamber may be configured to prevent oil or other components in a chamber outside of the cylinder from becoming contaminated. The gas exchange chamber may include an air chamber that is isolated from one or more of the combustion chamber and the chamber housing the actuator. The gas exchange chamber may be sealed from the combustion chamber by a seal, and may be sealed from the chamber housing the actuator by a seal. The seals may be stationary seals. The gas exchange chamber may be sealed from an oil chamber such that combustion products that may be present in blow-by gases are prevented or impeded from reaching oil in the oil chamber, thus keeping the oil clean. Communication between gas from the gas exchange chamber and oil in the oil chamber may be blocked.

Furthermore, the engine may include a piston and a piston rod configured to reciprocate linearly. The piston rod may be configured to move only in a linear direction (e.g., only up-and-down, without moving side-to-side). Different from a connecting rod in a conventional engine, there may be no lateral movement of the piston rod. The piston rod may be coupled to an actuator housed in an actuator chamber (e.g., oil chamber). To form a seal between the gas exchange chamber and the oil chamber, a gasket may be provided between the chambers that prevents blow-by gases from reaching the oil in the oil chamber while allowing the piston rod to slide up-and-down.

Furthermore, the gas exchange chamber may include passageways that allow communication of gases into or out of the gas exchange chamber. The passageways may be used to supply fresh air into the gas exchange chamber, or to supply gases to the combustion chamber. The passageways may enable exhaust gas recirculation (EGR). EGR may be useful to lower combustion temperature in the cylinder and to improve emissions.

The engine may include a mechanism to transform linear motion to rotative motion, or to transform motion of a piston rod to output of some other form. The mechanism may include a gear mechanism. The mechanism may be configured to enable the piston rod to move linearly in the same direction as the piston so that no side force acts on cylinder walls and so that sealing between the air chamber and the oil chamber may be achieved by a stationary gasket. Linear motion of the piston and piston rod may be transformed into rotative motion that turns a flywheel. The flywheel may be used to harness work of the engine. The flywheel may drive a wheel, or may power a generator, for example.

According to some embodiments of the disclosure, an engine may be provided that is compact and lightweight. The engine may achieve high efficiency and reduced environmental impact (e.g., emissions). The engine may achieve a high power-to-weight ratio.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

FIG. 1 illustrates an engine 1 consistent with embodiments of the present disclosure. Engine 1 may include a cylinder 110 configured to have a piston kit 56 slidably provided therein. Piston kit 56 includes piston 310 and piston rod 320. Cylinder 110 may have a combustion chamber 150 formed therein. Combustion chamber 150 may be formed by a bottom of piston 310, side walls of cylinder 110, and a cylinder head 14. Combustion chamber 150 may include a variable region in cylinder 110 that includes a swept volume formed by the bottom surface of piston 310. The swept volume may change as piston 310 moves from one end of cylinder 110 to an opposite end thereof.

Engine 1 may include a gas exchange chamber 400. Gas exchange chamber 400 may be adjacent to cylinder 110. Gas exchange chamber 400 may be external to cylinder 110. Piston rod 320 may extend through combustion chamber 150. In some embodiments, an air intake chamber may be provided above combustion chamber 150.

Furthermore, engine 1 may include a chamber 130 configured to house an actuator 300. Piston rod 320 may extend outside of cylinder 110 and into chamber 130. Actuator 300 may include a mechanism configured to transform linear motion of piston kit 56 to output of another form. For example, actuator 300 may be coupled to one end of piston rod 320 and may harness the motion of piston rod 320 reciprocating back and forth. Chamber 130 may be configured to contain a lubricant. The lubricant may be a liquid lubricant, such as engine oil. Actuator 300 may be configured to be lubricated by oil.

Gas exchange chamber 400 may be configured to prevent contaminants from reaching chamber 130. Gas exchange chamber 400 may be configured to prevent blow-by gases coming from combustion chamber 150 from infiltrating chamber 130.

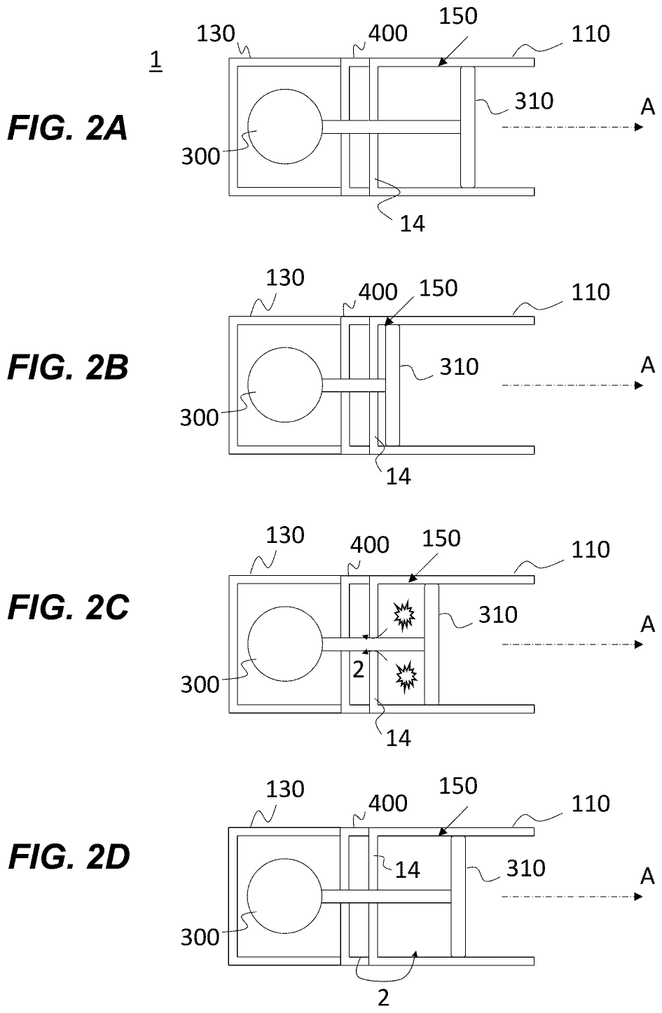

Reference is now made to FIGS. 2A-2D, which illustrate an operation of engine 1, consistent with embodiments of the present disclosure. As shown in FIG. 2A, piston 310 may move in a linear direction. Piston 310 may reciprocate back and forth (e.g., left and right in the view of FIG. 2A) along axis A. At the stage shown in FIG. 2A, combustion chamber 150 may be filled with gases, such as an air-fuel mixture. From the position of FIG. 2A, piston 310 may move so as to compress the gases in combustion chamber 150 (e.g., in the minus A direction; to the left in FIG. 2A).

At the stage shown in FIG. 2B, piston 310 may reach a combustion position. The combustion position may be at a point along axis A corresponding to the beginning of a combustion event in cylinder 110. Upon combustion, piston 310 may reverse direction. The combustion position may be a point where a predetermined compression ratio of gases in the combustion chamber is reached. For example, the combustion position may be a point where a compression ratio of the combustion chamber reaches 10:1 or 20:1, etc. Combustion may be initiated at the combustion position by activating an igniter, such as a spark plug or glow plug. In some embodiments, the combustion position may be a fixed position. In some embodiments, the combustion position may be a variable position that may be determined based on conditions of engine 1. For example, engine 1 may be configured to operate using auto-ignition, and the combustion position may be a point at which compression ratio in the combustion chamber is appropriate for spontaneous combustion of the type of fuel used.

The combustion position may be different from a maximum travel position of piston 310. Piston 310 may be permitted to travel until hitting cylinder head 14. For example, when piston rod 320 is not mechanically coupled to any other component (e.g., the piston is “free”), piston 310 may move along axis A until hitting a physical barrier. To prevent piston 310 from impacting cylinder head 14 in operation, engine 1 may be configured such that a clearance volume is provided between piston 310 and cylinder head 14.

In some embodiments, piston 310 may be configured to reciprocate between a first limit position and a second limit position. The limit positions may be set by actuator 300. The limit positions may be similar to the terms “top dead center” and “bottom dead center” in which a conventional piston may be constrained by a crankshaft to move between a position of maximum upward travel (e.g., a 0-degree position of the crankshaft), and a position of maximum downward travel (e.g., a 180-degree position of the crankshaft). In some embodiments of the disclosure, actuator 300 may physically limit the travel range of piston 310. In some embodiments, actuator 300 may include a crankshaft. In some embodiments, however, actuator 300 may be coupled to piston rod 320 but does not physically limit the travel range of piston 310. For example, actuator 300 may transform linear motion from piston rod 320 into rotative motion, and energy of the rotative motion may be harnessed by an electric generator that does not physically restrict actuator 300. Still, piston 310 may be prevented from hitting cylinder head 14 due to the pressure of compressed gases remaining in combustion chamber 150.

In operation of engine 1, combustion may occur after the air-fuel mixture in combustion chamber 150 is compressed. Combustion may cause the compressed air-fuel mixture in combustion chamber 150 to be converted to expansion gases having high pressure that cause piston 310 to move. FIG. 2C shows a stage where combustion has occurred and piston 310 is moving along axis A. As shown in FIG. 2C, some of the expansion gases may escape from combustion chamber 150 into other regions of engine 1. For example, blow-by gases 2 may escape combustion chamber 150. Blow-by gases 2 may blow past a barrier (e.g., a seal) that may aim to contain such gases. Gas exchange chamber 400 may be configured to trap blow-by gases 2. Blow-by gases 2 may be contained in gas exchange chamber 400 and may be prevented from entering chamber 130. Gas exchange chamber 400 may be configured to allow blow-by gases 2 to expand into the volume of gas exchange chamber 400, and to reduce the pressure of blow-by gases 2. Pressure of blow-by gases 2 may be reduced and a seal between gas exchange chamber 400 and chamber 130 may be able to contain blow-by gases 2 in gas exchange chamber 400.

As shown in FIG. 2D, blow-by gases 2 may be redirected to other regions of engine 1. Gas exchange chamber 400 may be configured to perform an EGR function. Gas exchange chamber 400 may redirect blow-by gases 2, along with other gases that may be contained in gas exchange chamber 400 such as fresh air, back into combustion chamber 150. Blow-by gases 2 may be delivered back into combustion chamber 150 where they may undergo more complete combustion (e.g., burning any unburned fuel). Additionally, blow-by gases 2 may include combustion by-products that may not be combustible. Such non-combustible material may take up volume within combustion chamber 150 (rather than, e.g., fresh air or fuel), and may partially inhibit combustion in cylinder 110. This may reduce a temperature of combustion in combustion chamber 150, and may allow for tuning of engine performance. Gas exchange chamber 400 may be configured to reduce harmful emissions of engine 1.

Blow-by gases 2 may originate due to combustion occurring in combustion chamber 150, and blow-by gases 2 may include gases at very high temperature (e.g., 400 degrees Celsius). High temperature gases leaking into other regions of engine 1, such as chamber 130, may harmfully impact engine performance. For example, oil that may be contained in chamber 130 may be heated, and may carbonize. Carbonized oil may form particulate matter (PM) that may come into contact with components and material in chamber 130, including liquid oil. The presence of PM in chamber 130 may cause increased friction within chamber 130, and the temperature of components and material in chamber 130 may further increase. Thus, infiltration of blow-by gases 2 into chamber 130 may cause excessive heating. Additionally, issues may be encountered with proper functioning of a positive crankcase ventilation (PCV) system, and more work may be required from engine 1 to drive components connected thereto.

Gas exchange chamber 400 may be configured to prevent blow-by gases 2 from entering chamber 130, and may prevent components or material in chamber 130 from being contaminated. Gas exchange chamber 400 may reduce the frequency at which oil of engine 1 may need to be changed.

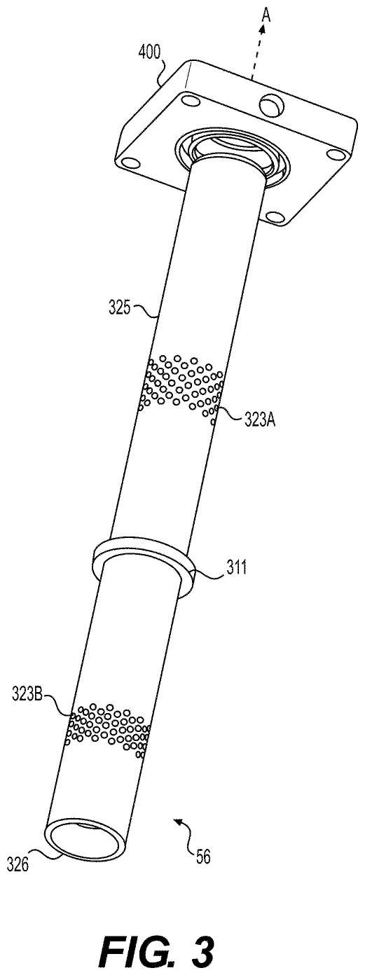

Reference is now made to FIG. 3, which illustrates a piston kit and gas exchange chamber, consistent with embodiments of the disclosure. Piston kit 56 may be configured to move along axis A. Piston kit 56 may include a double-sided piston 311 and a piston rod 325. Piston rod 325 may be configured to move through an opening in gas exchange chamber 400. Although FIG. 3 may show a piston kit 56 with piston 311 having a diameter only slightly larger than piston rod 325, it will be understood that many variations are possible. Piston 311 may be configured to have a diameter that is greater than the opening of gas exchange chamber 400 that piston rod 325 moves through.

Piston 311 may be slidably mounted in cylinder 110 (not shown in FIG. 3). Piston rod 325 may include a passageway that may extend at least partially therethrough. Piston rod 325 may include a hollow tube. There may be an interconnecting flow passage connecting a passage on a first side of piston 311 and a passage on a second side of piston 311. As shown in FIG. 3, piston rod 325 may include first openings 323A and second openings 323B. Intake air supplied through an open end 326 or through second openings 323B of piston rod 325 may be communicated through piston rod 325 and delivered to a combustion chamber of cylinder 110 via first openings 323A. In some embodiments, piston rod 325 may include a wall at one or both ends such that gas communication only occurs through first and second openings 323A, 323B.

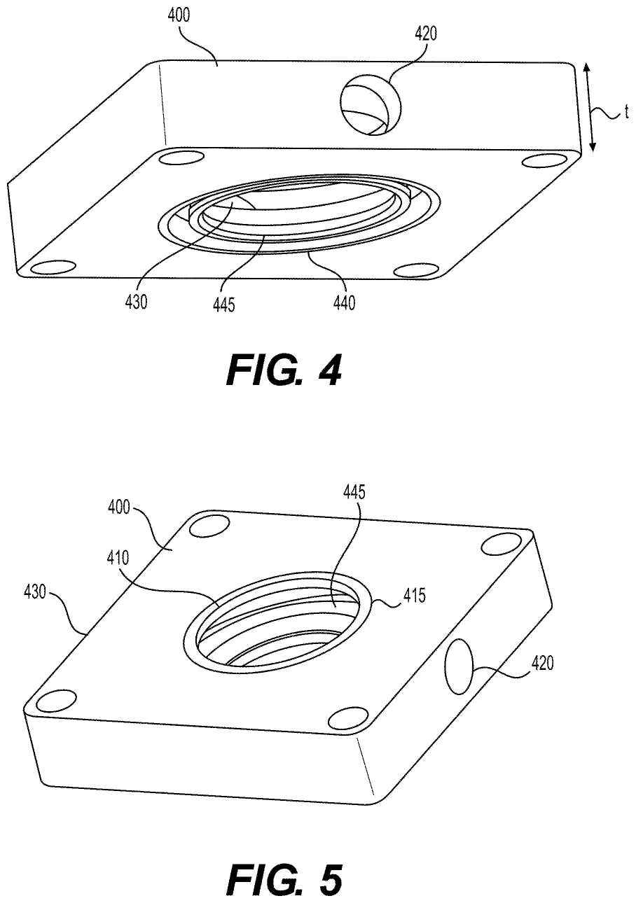

Reference is now made to FIGS. 4-10, which illustrate a gas exchange chamber, consistent with embodiments of the disclosure. As shown in FIG. 4, gas exchange chamber 400 may include a lower opening 440, a gas inlet 420, and a gas outlet 430. A seal 445 may be provided in lower opening 440. Seal 445 may be configured to seal gas exchange chamber 400 from an adjacent chamber. For example, gas exchange chamber 400 may be adjacent to chamber 130 (not shown in FIG. 4) and seal 445 may be configured to seal gas exchange chamber 400 from chamber 130. Seal 445 may be configured to fill a gap between a piston rod and an inner diameter of lower opening 440. Seal 445 may be an oil seal. Seal 445 may be configured to scrape oil that may be carried by a piston rod sliding along seal 445 and to contain the oil in chamber 130. Gas exchange chamber 400 may have a thickness t, with the thickness direction being parallel to axis A.

As shown in FIG. 5, gas exchange chamber 400 may include an upper opening 410. Upper opening 410 may be included in a sealing system configured to seal gas exchange chamber 400 from another chamber (e.g., combustion chamber 150). In some embodiments, an upper portion of gas exchange chamber 400 may be integrated with an engine head (e.g., cylinder head 14). Gas exchange chamber 400 may be included in engine head 14.

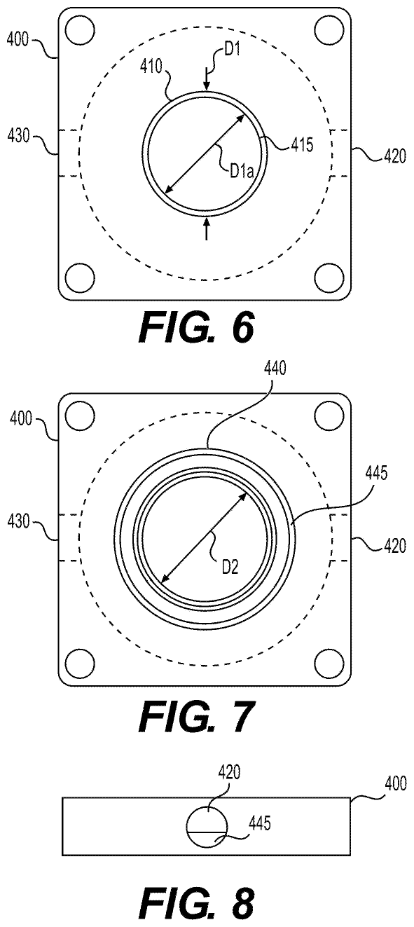

As shown in FIG. 5 and FIG. 6, gas exchange chamber 400 may include gas inlet 420 and gas outlet 430. Fresh air or other gases may be supplied to gas exchange chamber through gas inlet 420 and may be exhausted through gas outlet 430. Gas inlet 420 may communicate with an air intake system. Gas outlet 430 may communicate with an air cleaner or may be configured to recirculate gases from gas exchange chamber 400 directly into cylinder 110 (not shown in FIGS. 5 and 6).

As shown in FIG. 6, upper opening 410 may have a diameter D1. As shown in FIG. 7, an inner diameter of seal 445 may be D2. D1 and D2 may be the same or different. In some embodiments, D1 may be larger than D2 to accommodate a rod opening sealing system. For example, as shown in FIG. 6, a ring member 415 may be provided in upper opening 415. Ring member 415 may have an inner diameter D1a. D1a may be the same or substantially the same to that of D2.

FIG. 8 shows a side view of gas exchange chamber 400. Gas inlet 420 and gas outlet 430 may be aligned with one another. An opening may be formed straight through gas exchange chamber 400. Seal 445 may have a thickness such that at least a portion of seal 445 is visible through gas inlet 420 when viewing gas exchange chamber 400 from the side.

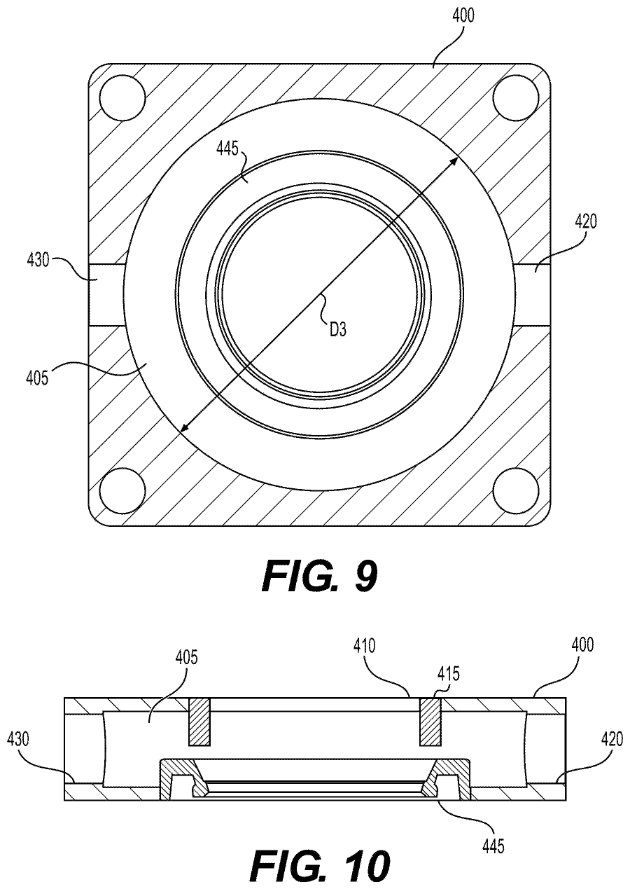

FIG. 9 is a cross-sectional view taken in a plane perpendicular to the thickness direction (see FIG. 4). As shown in FIG. 9, gas exchange chamber 400 may include an interior space 405. Interior space 405 may be defined by diameter D3. Interior space 405 may have a volume configured to allow blow-by gases 2 to expand such that pressure of blow-by gases 2 is reduced upon entering gas exchange chamber 400 from combustion chamber 150 (not shown in FIG. 9).

FIG. 10 is a cross-sectional view taken in a plane perpendicular to that of FIG. 9. As shown in FIG. 10, seal 445 may have a U-shape. Ring member 415 may be configured to block openings in a piston rod such that gas communication between the interior of the piston rod and interior space 405 of gas exchange member 440 is blocked.

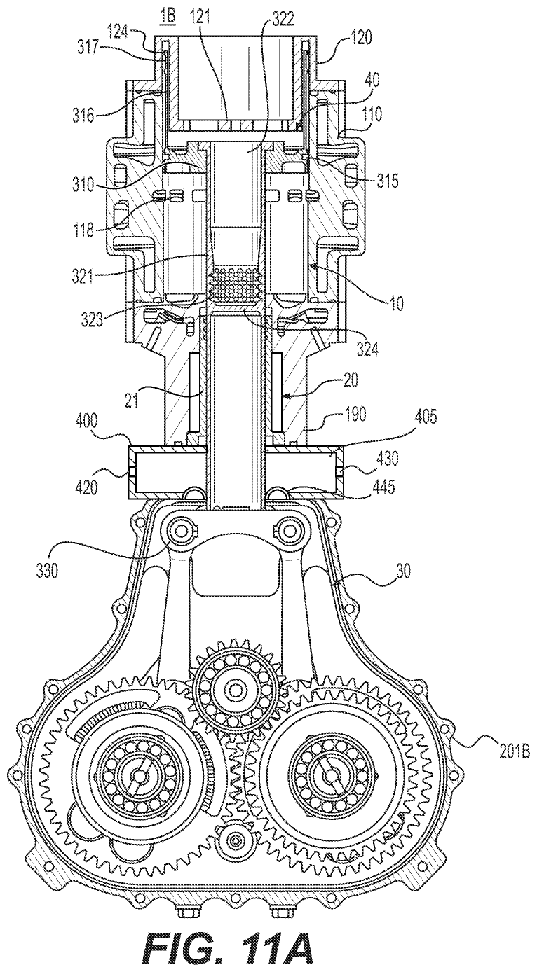

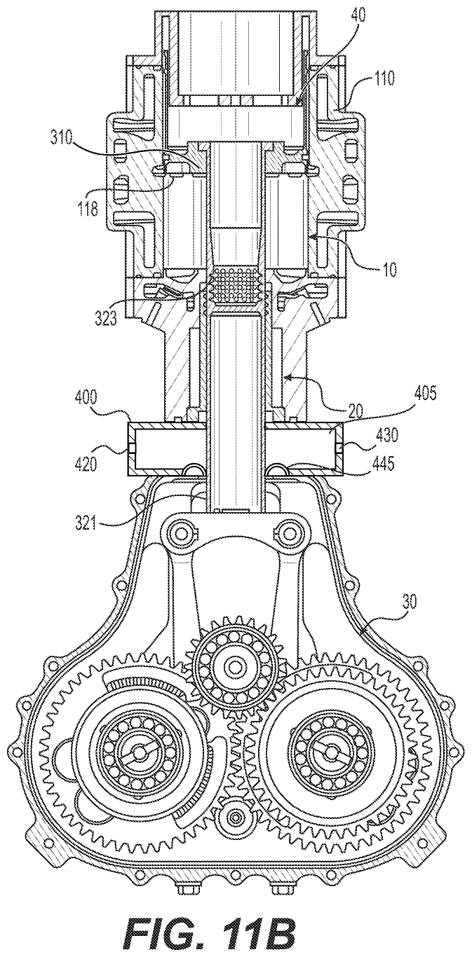

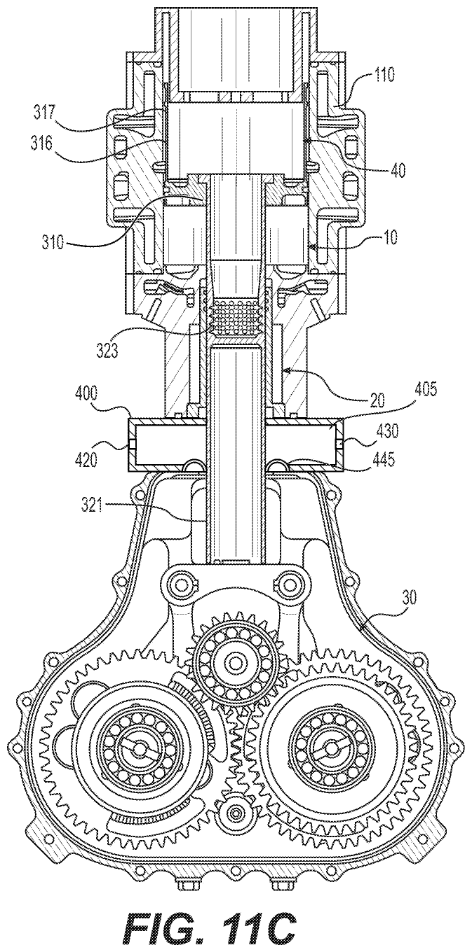

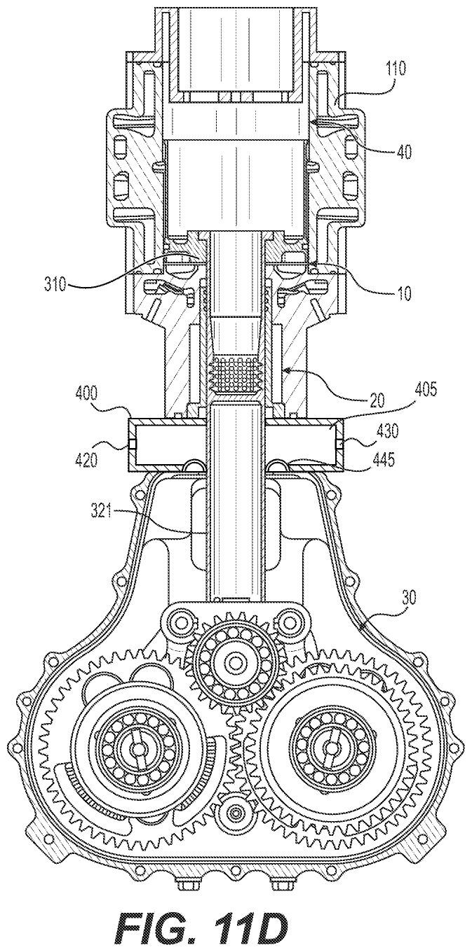

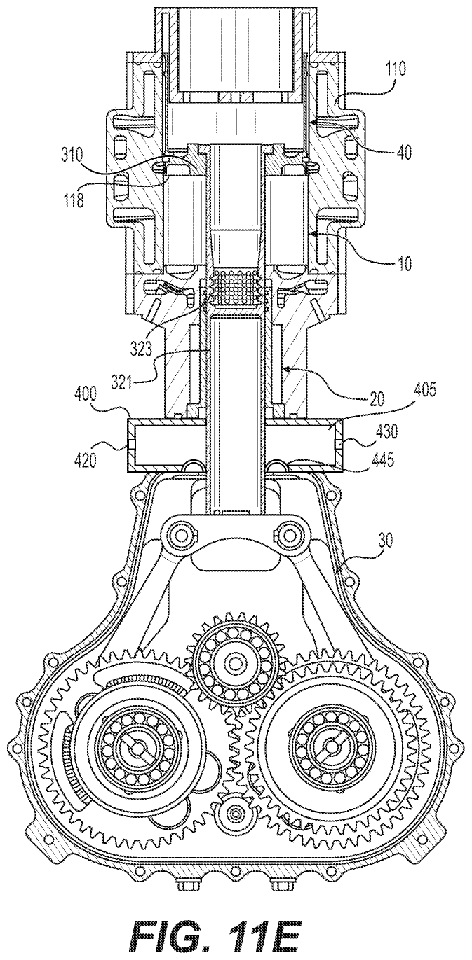

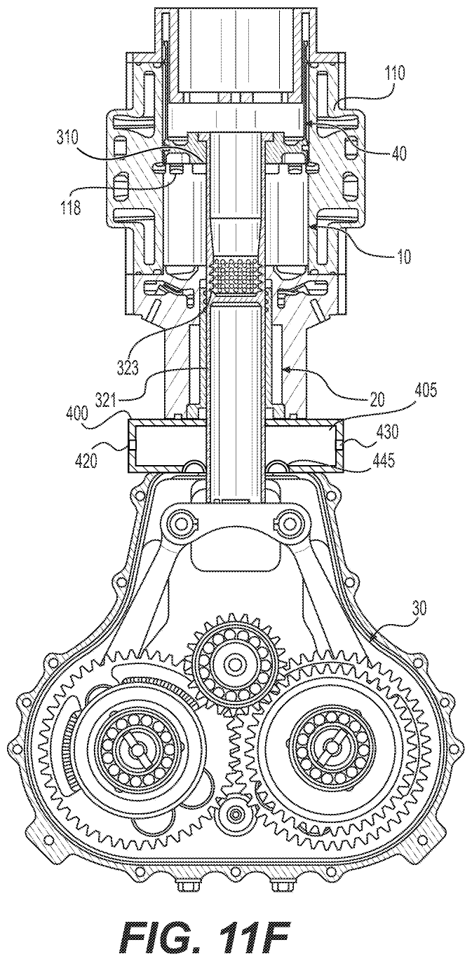

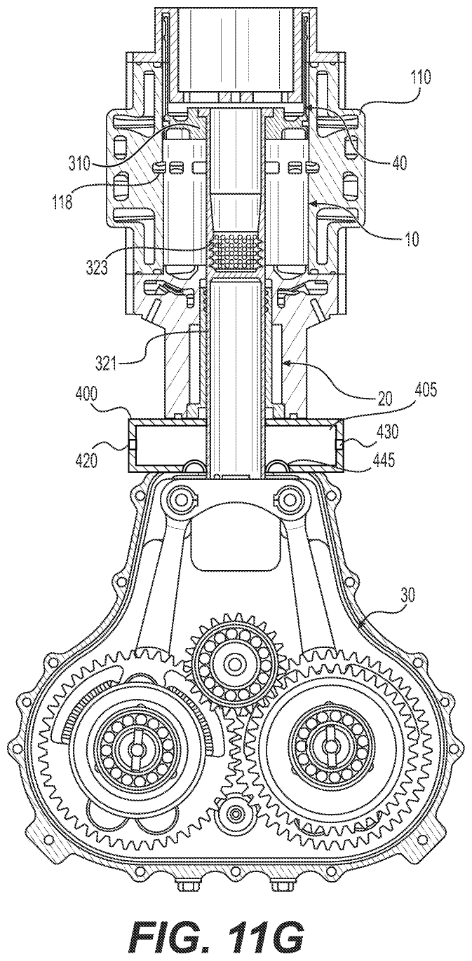

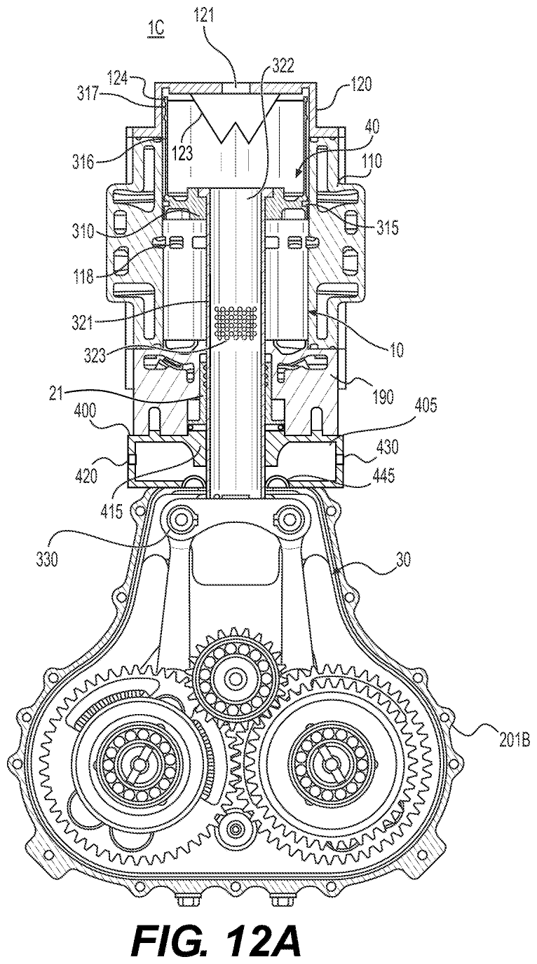

Reference is now made to FIGS. 11A-11G, which illustrates an engine 1B consistent with embodiments of the disclosure. Engine 1B may be similar to engine 1 but with an intake and exhaust system that shall be discussed as follows, as well as other features. An upper engine head 120 may include an opening 121 that may be configured to allow intake air to enter cylinder 110. A one-way valve (e.g., a reed valve) may be provided in opening 121 (not shown). Air may be allowed to freely enter cylinder 110 but is prevented from exiting through opening 121. An intake chamber 40 may be provided. Intake chamber 40 may be formed by a space between a top wall of upper engine head 120 and a top face of piston 310. Opening 121 may be configured to allow air to be drawn in as piston 310 moves down and increases the volume of intake chamber 40.

Piston 310 may be provided slidably within cylinder 110. Piston 310 may be configured to move in a linear direction with respect to engine 1B (e.g., the top-down direction of FIG. 11A). The linear direction may be aligned with an axis of cylinder 110. A piston rod 321 may be connected to piston 310. Piston 310 may have an opening at its center such that piston rod 321 extends therethrough. Piston rod 321 may be configured to reciprocate in the linear direction, along with piston 310. Piston rod 321 may include an opening 322 at a first end of piston rod 321. A second end of piston rod 321 may be connected to support member 330. Between the first end and the second end of piston rod 321, there may be provided a wall 324. Wall 324 may be configured to block air flow through piston rod 321. Piston rod 321 may be configured to allow air to flow at least partially therethrough. For example, piston rod 321 may include a passageway that is formed from opening 322 to an opening 323. Opening 323 may include a plurality of holes extending through a wall of piston rod 321. Intake air entering through opening 121 in head 120 may travel through piston rod 321 via opening 322 and opening 323 into first chamber 10 in cylinder 110.

Intake air in engine 1B may be pressurized. Intake chamber 40 may act as a compressor. Piston 310 may move downwards in the view of FIG. 11A to draw in air from opening 121. Piston 310 may move upwards in the view of FIG. 11A to compress air contained in intake chamber 40. A valve provided in opening 121 may prevent air from escaping from chamber 40 and allow it to become compressed. Compressed air may be provided to a combustion chamber in cylinder 110 through piston rod 321.

Cylinder 110 may include exhaust opening 118 that may be formed in a wall of cylinder 110. Exhaust opening 118 may include a plurality of openings. When piston 310 exposes exhaust opening 118 in first chamber 10, gases in first chamber 10 may be allowed to escape cylinder 110. Piston 310 may expose exhaust opening 118 when piston 310 is above exhaust opening 118 in the view of FIG. 11A. It will be understood that phrases such as “piston 310 is above exhaust opening 118” take into account a piston ring of piston 310. For example, exhaust opening 118 may begin to be exposed when a piston ring provided at about the midpoint of piston 310 moves past an edge of exhaust opening 118.

FIG. 11A may illustrate a beginning of an intake phase. Air may enter engine 1B through opening 121 in upper engine head 120. Some air may be held in intake chamber 40 at least temporarily. Air may travel through piston rod 321 and be supplied to first chamber 10 in cylinder 110. When piston 310 blocks exhaust opening 118 (e.g., when piston 310 is above exhaust opening 118), an intake path may be in communication with exhaust opening 118 and engine 1B may be in a scavenging phase. Air may be supplied to first chamber 10 and may push out the prior contents of first chamber 10 to exit through exhaust opening 118. First chamber 10 may act as a combustion chamber.

As shown in FIG. 11A, piston 310 may include an upper wall 316. Upper wall 316 may be configured to extend into an accommodating space 124 in upper engine head 120. A groove 317 may be provided in upper wall 316. In some embodiments, a piston ring (not shown) may be provided in groove 317 that is configured to seal intake chamber 40 from first chamber 10. The piston ring in groove 317 may work together with a piston ring in groove 315 (not shown) to seal chambers above and below piston 310. The two seals may provide an intermediary space for gas.

A lower engine head 190 may be provided that is connected to cylinder 110. Lower engine head 190 may define a bottom of cylinder 110 and a bottom of first chamber 10. Lower engine head 190 may include a space for a second chamber 20. A bearing 21 may be provided in second chamber 20. Bearing 21 may be configured to allow piston rod 321 to slide along bearing 21 in the linear direction. Bearing 21 may be a linear bearing. Bearing 21 may be configured to restrict lateral movement (e.g., in the left-right direction of FIG. 11A) of piston rod 321. Bearing 21 may be an example of a rod holder. Bearing 21 may include a bushing. A seal may be provided to seal second chamber 20 from first chamber 10 and third chamber 30.

A base of engine 1B may include block 201B. Block 201B may include third chamber 30. Third chamber 30 may contain an actuator such as a mechanism to transform output of rod to output of another form, e.g., transform linear reciprocating motion to rotative motion. Support member 330 may be configured to move together with piston rod 321 and may cause gears of the mechanism to rotate. Rotative motion may be transferred through other members and may be output to, for example, a flywheel.

As shown in FIG. 11B, piston 310 may continue to move downward. FIG. 11B may illustrate a point where opening 323 in piston rod 321 moves outside cylinder 110, and a passageway in piston rod 321 may no longer be in communication with first chamber 10. Communication between the passageway in piston rod 321 and first chamber 10 may be blocked when opening 323 moves entirely past a seal that seals first chamber 10 from second chamber 20. When opening 323 moves out of first chamber 10, exhaust opening 118 may be at least partially exposed by piston 310. In some embodiments, piston rod 321 and cylinder 110 may be configured such that exhaust opening 118 is closed off by piston 310 before opening 323 in piston rod 321 moves outside cylinder 110. In some embodiments, piston rod 321 and cylinder 110 may be configured such that exhaust opening 118 and opening 323 in piston rod 321 are closed off together. Piston rod 321 and cylinder 110 may be configured by being sized such that gas communication is controlled in such a manner. Locations of piston rings and seals, etc., may also influence gas exchange behavior.

When exhaust opening 118 is blocked by piston 310, a compression phase may occur in first chamber 10. Intake air previously supplied to first chamber 10 may be trapped in first chamber 10 and may be compressed as piston 310 moves and reduces the volume of first chamber 10.

Second chamber 20 may be isolated from first chamber 10 and from third chamber 30. Third chamber 30 may contain lubricant for lubricating the mechanism transforming linear motion of piston rod 321. First chamber 10 and third chamber 30 may be isolated from one another by gas exchange chamber 400.

FIG. 11C shows a position where piston 310 continues to move downward. Piston 310 may completely cover exhaust opening 118. At the position shown in FIG. 11C, the compression phase may be continuing. Opening 323 in piston rod 321 may be in a region of second chamber 20. In some embodiments, second chamber 20 may be isolated from opening 323 in piston rod 321 due to bearing 21 blocking opening 323. In some embodiments, second chamber 20 may be omitted, and gas exchange chamber 400 may be directly adjacent first chamber 10 and third chamber 30. Fuel injection may occur in first chamber 10 while gases continue to be compressed.

FIG. 11D shows a position where piston 310 has reached a combustion position (e.g., a bottom limit position similar to a BDC position of a piston in a conventional engine). The volume of first chamber 10 may be at a minimum. At this point, combustion may occur in first chamber 10. An expansion phase may begin in first chamber 10 thereafter. The expansion phase may include a combustion phase portion. During the expansion phase, the pressure of expansion gases in first chamber 10 may become very high and some blow-by may occur. Some gases may blow past piston 310 or past a seal between first chamber 10 and other regions of engine 1B. Some gases may escape into second chamber 20 or into gas exchange chamber 400. However, gas exchange chamber 400 may act as an air gap or a trapping chamber and may prevent or impede blow-by gases from reaching third chamber 30.

As shown in FIG. 11E, in the expansion phase, piston 310 may have reversed direction and may be traveling upward. At the point illustrated in FIG. 11E, piston 310 may begin to uncover exhaust opening 118. For example, a bottom face of piston 310 may have reached a bottom of exhaust opening 118. Exhaust opening 118 may be exposed to an interior of first chamber 10 and an exhaust phase may begin in first chamber 10. Furthermore, opening 323 in piston rod 321 may also begin to become exposed.

At the point shown in FIG. 11F, opening 323 in piston rod 321 may have entered cylinder 110. Intake gases may be supplied to cylinder 110 via piston rod 321. Intake air from intake chamber 40 may travel through piston rod 321 and be supplied to first chamber 10 through opening 323. The intake air may have been pressurized in intake chamber 40. During the expansion phase, first chamber 10 may be filled with expansion gases. Introduction of fresh air may help to force expansion gases out of cylinder 110 through exhaust opening 118. Scavenging may be occurring as air is supplied to cylinder 110 while exhaust gases are exiting.

FIG. 11G shows a point where piston 310 has reached a top maximum travel position. At this point, scavenging may have completed in first chamber 10. In some embodiments, piston rod 321 and cylinder 110 may be configured such that some fresh air is supplied to first chamber 10 and is allowed to escape from cylinder 110 before a next compression phase begins.

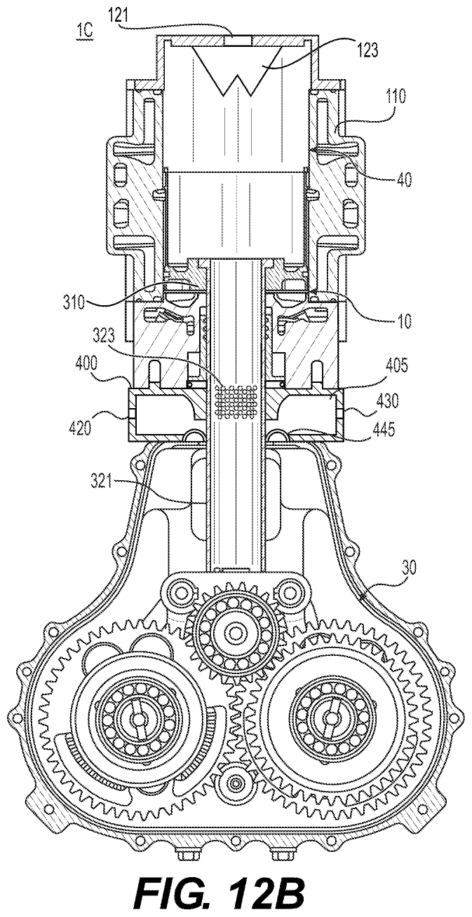

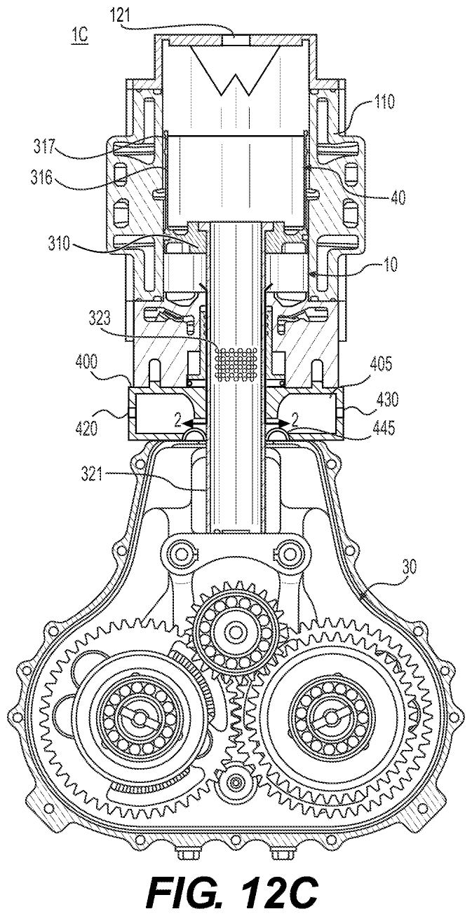

Reference is now made to FIGS. 12A-12C which show an engine 1C, consistent with embodiments of the disclosure. Engine 1C may be similar to engine 1B except that an arrangement of engine heads and gas exchange chamber may be modified, among other differences. As shown in FIG. 12A, engine 1C may include gas exchange chamber 400. Ring member 415 may be provided in gas exchange chamber 400. Ring member 415 may be configured to block opening 323, and to inhibit communication of gases between interior of piston rod 321 and interior space 405 of gas exchange chamber 400.

Furthermore, engine 1C may include a valve member 123 adjacent to opening 121. Upper engine head 120 may have a configuration with a flat top. Exchange of gases between intake chamber 40 and regions external to cylinder 110 may be restricted by a one-way valve. Valve member 123 may selectively allow gases to be exchanged. For example, air may be permitted to enter intake chamber 40 when pressure outside intake chamber 40 (e.g., pressure of air pressing against opening 121, which may be atmospheric pressure) is greater than pressure inside intake chamber 40. Air inside of intake chamber 40 may be prevented from escaping, even when pressure inside intake chamber 40 is greater than pressure outside intake chamber 40. Valve member 123 may be configured to control an interior volume of intake chamber 40. For example, valve member 123 may be provided to reduce volume in intake chamber 40 and allow compressed gases in intake chamber 40 to reach a higher pressure.

As shown in FIG. 12B, piston 310 may reach a bottom limit of piston travel that may be a combustion position. At this position, opening 323 in piston rod 321 may be in a region of gas exchange chamber 400. However, ring member 415 may cover opening 323, and air or other gases may be prevented from communicating between gas exchange chamber 400 and the interior of piston rod 321. Ring member 415 may have a thickness that is based on the bottom limit of piston travel for piston 310, and that may be determined to ensure coverage of opening 323. Ring member 415 may form an integral part of gas exchange chamber 400.

Ring member 415 may be configured so as not to interfere with trapping of blow-by gases. For example, ring member 415 may have a thickness that is less than that of gas exchange chamber 400. A gap may exist between ring member 415 and seal 445. As shown in FIG. 12C, engine 1C may be configured such that blow-by gases 2 that may escape from first chamber 10 in cylinder 110 reach gas exchange chamber 400 and are contained there or may be transmitted to other region of engine 1C in a controlled manner, such as through gas outlet 430.

Gas exchange chamber 400 may include grooves configured to mate with lower engine head 190. Gas exchange chamber 400 may couple to lower engine head 190 in an interlocking manner. Furthermore, bearing 21 may be configured to support piston rod 321 while bearing against engine head 190. Bearing 21 may include a bushing. A seal (e.g., an O-ring) may be provided between bearing 21 and gas exchange chamber 400.

To expedite the foregoing portion of the disclosure, various combinations of elements are described together. It is to be understood that aspects of the disclosure in their broadest sense are not limited to the particular combinations previously described. Rather, embodiments of the invention, consistent with this disclosure, and as illustrated by way of example in the figures, may include one or more of the following listed features, either alone or in combination with any one or more of the following other listed features, or in combination with the previously described features.

For example, there may be provided an internal combustion engine configured to have a piston reciprocating in a cylinder. The engine may be configured such that blow-by gases pass from a combustion chamber in the cylinder to an area external to the cylinder. There may also be provided the following elements:
the piston is connected to a rod configured to reciprocate in a linear direction.
the engine comprising a gas exchange chamber configured to trap the blow-by gases in a space between the cylinder and a chamber housing an actuator connected to an end of the rod.
wherein the blow-by gases pass between the rod and a rod holder.
wherein the gas exchange chamber is configured to prevent the blow-by gases from reaching the chamber that houses a fluid.
wherein the fluid includes a liquid lubricant.
wherein the fluid includes oil vapor.
wherein the rod holder includes a bearing configured to allow the rod to slide along the linear direction against the bearing.
wherein the bearing includes a bushing.
wherein the actuator includes an electrical generator.
wherein the actuator includes a mechanism configured to transfer linear reciprocating motion of the rod to rotative motion.
wherein the gas exchange chamber is included in a cylinder head.
wherein the engine includes a linear reciprocating engine.

Furthermore, for example, there may be provided an internal combustion engine. There may also be provided the following elements:
a piston connected to a rod and configured to reciprocate in a cylinder.
wherein the engine is configured to contain, in a gas exchange chamber, blow-by gases escaping from a combustion chamber in the cylinder through a space between the rod and a member surrounding the rod.
wherein the member surrounding the rod includes a bushing configured to allow the rod to move linearly along an axis and prevent the rod from moving perpendicular to the axis.
wherein the gas exchange chamber is configured to prevent the blow-by gases from contaminating a further chamber.
wherein the further chamber includes a lubricant chamber.
wherein the further chamber houses a mechanism configured to transform linear reciprocating motion of the rod to another form.
wherein the engine is configured to recirculate the blow-by gases into the combustion chamber and to decrease emissions.
wherein the gas exchange chamber includes an air inlet and an air outlet.
wherein the gas exchange chamber includes a clean air chamber between the combustion chamber and an end of the rod.
wherein the gas exchange chamber includes a seal configured to seal the gas exchange chamber from the further chamber.
a piston connected to a rod extending from a first side of the piston, the piston configured to reciprocate in a cylinder having a combustion chamber formed between the first side of the piston and a head opposite the first side of the piston.
a gas exchange chamber configured to contain blow-by gases passing, from the combustion chamber, through a space between and the rod and a member surrounding the rod.
wherein the member surrounding the rod includes the head.
wherein the engine includes a linear reciprocating engine and the rod is configured to linearly reciprocate along an axis of the cylinder.
a cylinder including a combustion chamber.
a piston slidably mounted within the cylinder and configured to linearly reciprocate along an axis in the cylinder.
a piston rod connected to the piston, the piston rod configured to linearly reciprocate along the axis, and the piston rod having an end extending outside the cylinder.
a gas exchange chamber, the gas exchange chamber configured to communicate gases coming from the cylinder to another location in the engine.
wherein the gas exchange chamber is arranged between the cylinder and a chamber housing an actuator configured to extract work from motion of the piston.
a seal configured to seal the gas exchange chamber from the chamber housing the actuator.
wherein the gas exchange chamber is configured to communicate gases coming from the cylinder to an air filter.
wherein the end of the piston rod extending outside the cylinder is configured to reciprocate between a first maximum travel position and a second maximum travel position, the first maximum travel position and the second maximum travel position being on the axis.
wherein the first maximum travel position and the second maximum travel position are external to the cylinder.
an air supply, wherein the air supply is configured to supply fuel-free air to the gas exchange chamber.

Furthermore, for example, there may be provided a linear reciprocating internal combustion engine. There may also be provided the following elements:
a piston configured to linearly reciprocate along an axis in a cylinder.
a piston rod connected to the piston, the piston rod configured to linearly reciprocate along the axis.
a first chamber that includes a combustion chamber in the cylinder.
a second chamber that includes a gas exchange chamber.
a third chamber configured to accommodate an end of the piston rod that extends outside the cylinder.
a seal between the second chamber and the third chamber, wherein the seal is configured to prevent gases in the second chamber from entering the third chamber.
a partition between the second chamber and the third chamber.
wherein the seal is provided in an opening in the partition.
wherein the piston rod is prevented from moving in a direction perpendicular to the axis.

1-32. (canceled)

33. An internal combustion engine configured to have a piston reciprocating in a cylinder in which blow-by gases pass from a combustion chamber in the cylinder to an area external to the cylinder, the piston connected to a rod configured to reciprocate in a linear direction, wherein
the engine comprises a gas exchange chamber configured to trap the blow-by gases in a space between the cylinder and a chamber housing an actuator connected to an end of the rod.

34. The engine of claim 33, wherein the engine is configured such that the blow-by gases pass between the rod and a rod holder.

35. The engine of claim 33, wherein the gas exchange chamber is configured to prevent the blow-by gases from reaching the chamber that houses a fluid.

36. The engine of claim 35, wherein the fluid includes a liquid lubricant.

37. The engine of claim 35, wherein the fluid includes oil vapor.

38. The engine of claim 34, wherein the rod holder includes a bearing configured to allow the rod to slide along the linear direction against the bearing.

39. The engine of claim 38, wherein the bearing includes a bushing.

40. The engine of claim 33, wherein the actuator includes an electrical generator.

41. The engine of claim 33, wherein the actuator includes a mechanism configured to transform linear reciprocating motion of the rod to rotative motion.

42. The engine of claim 33, wherein the gas exchange chamber is included in a cylinder head.

43. An internal combustion engine comprising:
a piston connected to a rod and configured to reciprocate in a cylinder,
wherein the engine is configured to contain, in a gas exchange chamber, blow-by gases escaping from a combustion chamber in the cylinder through a space between the rod and a member surrounding the rod.

44. The engine of claim 43, wherein the member surrounding the rod includes a bushing configured to allow the rod to move linearly along an axis and prevent the rod from moving perpendicular to the axis.

45. The engine of claim 43, wherein the gas exchange chamber is configured to prevent the blow-by gases from contaminating a further chamber.

46. The engine of claim 45, wherein the further chamber includes a lubricant chamber.

47. The engine of claim 46, wherein the further chamber houses a mechanism configured to transform linear reciprocating motion of the rod to another form.

48. The engine of claim 43, wherein the engine is configured to recirculate the blow-by gases into the combustion chamber and to decrease emissions.

49. The engine of claim 43, wherein the gas exchange chamber includes an air inlet and an air outlet.

50. The engine of claim 43, wherein the gas exchange chamber includes a clean air chamber between the combustion chamber and an end of the rod.

51. The engine of claim 45, wherein the gas exchange chamber includes a seal configured to seal the gas exchange chamber from the further chamber.

52. An internal combustion engine comprising:
a piston connected to a rod extending from a first side of the piston, the piston configured to reciprocate in a cylinder having a combustion chamber formed between the first side of the piston and a head opposite the first side of the piston; and
a gas exchange chamber configured to contain blow-by gases passing, from the combustion chamber, through a space between and the rod and a member surrounding the rod.

53. The engine of claim 52, wherein the member surrounding the rod includes the head.

54. The engine of claim 52, wherein the engine includes a linear reciprocating engine and the rod is configured to linearly reciprocate along an axis of the cylinder.

55. The engine of claim 52, wherein the engine includes a single-sided piston.

56. The engine of claim 52, wherein the engine includes a double-sided piston.

57. An internal combustion engine comprising:
a cylinder including a combustion chamber;
a piston slidably mounted within the cylinder and configured to linearly reciprocate along an axis in the cylinder;
a piston rod connected to the piston, the piston rod configured to linearly reciprocate along the axis, and the piston rod having an end extending outside the cylinder; and
a gas exchange chamber, the gas exchange chamber configured to communicate gases coming from the cylinder to another location in the engine.

58. The engine of claim 57, wherein the gas exchange chamber is arranged between the cylinder and a chamber housing an actuator configured to extract work from motion of the piston.

59. The engine of claim 58, further comprising:
a seal configured to seal the gas exchange chamber from the chamber housing the actuator.

60. The engine of claim 57, wherein the gas exchange chamber is configured to communicate gases coming from the cylinder to an air filter.

61. The engine of claim 57, wherein the end of the piston rod extending outside the cylinder is configured to reciprocate between a first maximum travel position and a second maximum travel position, the first maximum travel position and the second maximum travel position being on the axis.

62. The engine of claim 61, wherein the first maximum travel position and the second maximum travel position are external to the cylinder.

63. The engine of claim 57, further comprising:
an air supply, wherein the air supply is configured to supply fuel-free air to the gas exchange chamber.

64. A linear reciprocating engine comprising:
a piston configured to linearly reciprocate along an axis in a cylinder;
a piston rod connected to the piston, the piston rod configured to linearly reciprocate along the axis;
a first chamber that includes a combustion chamber in the cylinder;
a second chamber that includes a gas exchange chamber;
a third chamber configured to accommodate an end of the piston rod that extends outside the cylinder; and
a seal between the second chamber and the third chamber, wherein the seal is configured to prevent gases in the second chamber from entering the third chamber.

65. The engine of claim 64, further comprising:
a partition between the second chamber and the third chamber, wherein
the seal is provided in an opening in the partition, and
the piston rod is prevented from moving in a direction perpendicular to the axis.

66. The engine of claim 64, further comprising:
a ring member provided in the gas exchange chamber.
